(19) United States
(12) Patent Application Publication
(10) Pub. No.: US 2001/0030720 A1
(43) Pub. Date: Oct. 18, 2001

(54) Cholesteric liquid crystal color filter, a manufacturing method thereof and a display device for using the same

(76) Inventor: Mitsuyoshi Ichihashi, Shizuoka-ken (JP)

Correspondence Address: SUGHRUE, MION, ZINN, MACPEAK & SEAS, PLLC, 2100 Pennsylvania Avenue, N.W. Suite 800, Washington, DC, 20037-3213, US

(21) Appl. No.: 09/793,119

(22) Filed: Feb. 27, 2001

(30) Foreign Application Priority Data
Feb. 29, 2000 (JP) 2000-53217

(51) Int. Cl. G02F 1/1335

(52) U.S. Cl. 349/106

(57) ABSTRACT

A cholesteric liquid crystal layer color filter comprising a first cholesteric liquid crystal layer and second cholesteric liquid crystal layer wherein colors of the first cholesteric liquid layer are a first color and a second color; colors of the second cholesteric liquid crystal layer are a color which is the same as or similar to the second color and a third color and on the first color region of the first cholesteric liquid crystal layer, a region of the second cholesteric liquid crystal layer having a color which is the same as or similar to the second color and a region having the third color are respectively disposed, on the second color region of the first cholesteric liquid crystal layer, a third color region of the second cholesteric liquid crystal layer is formed.

### BACKGROUND OF THE INVENTION

1. Field of the Invention

The present invention relates to cholesteric liquid crystal color filter used in a display device and obtained by patterning a cholesteric liquid crystal compound displaying selective reflection, a method thereof and a display device using the same.

2. Description of the Related Art

The color filter used in a liquid color crystal display is generally composed of red (R), green (G) and blue (B) pixels, and a black matrix for improving the display contrast between the pixels.

Conventionally, this type of color filter is generally one in which a pigment is dispersed in a resin or one in which a dye is used. Methods for manufacturing a color filter are usually applied in which method these colored resins solutions are coated onto a glass substrate using a spin coat or the like, to thereby form a color resist layer and, patterning is then carried out by photolithography to form a color filter pixel, or in which the color pixel is printed directly on the substrate.

However, in the manufacturing method of a color filter using a printing method, there are drawbacks in that the pixel resolution is low and it is difficult to produce a high resolution image pattern. In the manufacturing method using the spin coat method, there is a large amount of material loss, and in the case where a substrate having a large area is coated, there is the disadvantage that uneveness of the coat is large.

Further, in a method of manufacturing using an electrodeposition method, a color filter can be obtained which has a comparatively high resolution and the unevenness of the color layer is relatively small, but there are problems with this method since the manufacturing process is complicated and managing the solutions is difficult.

As a result of the above problems, there is a demand for a method of manufacturing a color filter in which the amount of material loss is decreased and a high quality product can be effectively and easily manufactured.

The color filter is required to have properties of transmittance and high color purity. In a method in which a dye is used, transmittance and purity may be improved by optimizing the type of dye and the color resin. Also, in a method using a pigment, transmittance and purity may be improved by using a fine pigment which is more thoroughly dispersed.

In recent years, the demand for transmittance and color purity in the color filters used in the liquid crystal display (LCD) panel has been extraordinarily high.

However, particularly in the color filter for the reflection type LCD, it is difficult to simultaneously achieve a degree of whiteness like white paper, a high contrast, and color reproduction. Further, since the color filters obtained by the conventional manufacturing methods in which a color filter is manufactured by dyeing a resin or by dispersing a pigment in a resin, are light absorption type color filters, color purity due to transmittance improvement has almost reached a limit.

A color filter for which polarized light is used is known in which filter a mixture containing as a main component, a cholesteric liquid crystal, a polymerizable monomer, a polymerization initiator, and the like, is finely patterned.

In the color filter for which polarized light is used, because a predetermined amount of light is reflected and the rest permeates through to display an image, the efficiency of light use is high and the degree of transmittance and color purity is superior to that of the light absorption type color filter.

To manufacture the color filter for which polarized light is used, a method in which a membrane is formed by a spin coat method or the like on the surface of a substrate which has been subjected to an orientation process is generally used from the viewpoint that a membrane having uniform thickness can be formed. However, in this method, there is a large amount of material loss and in a case where high cost liquid crystal material is used, there is a problem that manufacturing cost becomes high.

Further, in the spin coat method, controlling the thickness of the membrane in the membrane formation process is difficult and in the case where liquid crystal material is used, the thickness of the membrane tends to affect the reflectance property. As a result, the yield factor is low.

Further, in a material having a photosensitive composition layer which includes liquid crystals, a sufficient amount, which allows patterning by a photolithography method, of components excluding the liquid crystal and the chiral compound, namely, the polymerizable monomer and the polymerization initiator which can control orientation movement of the liquid crystal cannot be included in the photosensitive composition layer, so it is difficult for all the properties of color reproduction and patterning, and hardening reactivity to be achieved simultaneously.

In addition, since it is necessary to define the color filter into three colors, patterning by light radiation, development and rinsing cause large material loss thus such a method is not desirable in view of environmental problems. Also, in a patterning method using a photoisomerization chiral compound, the intermediate transmittance region of the photo-mask is used for color formation and because the amount of light easily affects the chromaticity, increasing the color uniformity in the respective portions of the filter is difficult. Even in a case in which the filter color definition is carried out by a chiral compound whose helical twisting power (HTP) has a large temperature dependency, it is necessary to maintain the temperature uniformly throughout a large area, at a temperature which is in the middle of the range of the temperatures which are made to vary at the time of patterning. As a result, as in the case above, there is a problem in that it is extremely difficult to obtain color uniformity of respective portions of the filter.

### SUMMARY OF THE INVENTION

The object of the present invention is to provide a high quality cholesteric liquid crystal color filter having a simple structure which can achieve color uniformity of respective portions of the filter, a simple manufacturing method thereof and further a color display device for using this color filter.

The above problems can be solved with a color filter which makes possible a full color display using a cholesteric liquid crystal layer having a two layer structure using two predetermined colors which are selected from three colors, a manufacturing method thereof, and a display device using the cholesteric liquid crystal and the method thereof.

The present invention provides a cholesteric liquid crystal color filter comprising:

(a) a first cholesteric liquid crystal layer having a first region of a first color and a second region of a second color; and

(b) a second cholesteric liquid crystal layer having a first region of a color the same as or similar to the second color, and a second region of a third color, with the first region of the second layer and the second region of the second layer formed on the first region of the first layer, and the second region of the second layer formed on the second region of the first layer.

Further, the invention provides the cholesteric liquid crystal layer color filter of claim 2, wherein a ratio of the total area of the first region in the first layer to the total area of the second region in the first layer, is substantially 2:1, and a ratio of the total area of the first region in the second layer to the total area of the second regions together in the second layer, is substantially 1:2.

Still further, the invention provides the cholesteric liquid crystal layer color filter of claim 1, wherein the first color is selected from the group of colors consisting essentially of red, blue and green, and the second color is selected from one of the other two remaining colors of the group after the first color has been selected.

Also, the invention provides the method of claim 5, wherein at least one of, the step of forming a first cholesteric liquid crystal layer, and the step of forming a second cholesteric liquid layer, is performed by a transfer technique.

### BRIEF DESCRIPTION OF THE DRAWINGS

FIG. 1 is a cross-sectional diagram illustrating a schematic structure of a cholesteric liquid crystal color filter of the present invention.

FIG. 2 is a cross-sectional diagram illustrating a schematic structure of a conventional two-layer cholesteric liquid crystal color filter.

FIGS. 3A through 3J are cross-sectional diagrams illustrating the manufacturing process of a cholesteric liquid crystal color filter of the present invention.

FIGS. 4A through 4E are cross-sectional diagrams illustrating a part of another manufacturing process of a cholesteric liquid crystal color filter which uses a photo-reactive chiral compound in the present invention.

FIG. 5 is a cross-sectional diagram illustrating a schematic structure of a transmission type LCD which is an example of a display device using the cholesteric liquid crystal color filter of the present invention.

FIG. 6 is a cross-sectional diagram illustrating another display device using the cholesteric liquid crystal color filter of the present invention.

### DESCRIPTION OF THE PREFERRED EMBODIMENTS

A detailed description of the preferred embodiments of the present invention follows.

FIG. 1 is cross-sectional view illustrating a preferred embodiment of a schematic structure of the two-layer cholesteric liquid crystal color filter of the present invention. There are two types of regions in the first cholesteric liquid crystal layer, one of the two has a hue which reflects green light and another has a hue which reflects blue light . Moreover, there are two types of regions in the second cholesteric liquid crystal layer, one of the two has the hue which reflects blue light which is the same in the first layer and another has a hue which is unlike those used in the first layer and which reflects red light. In FIG. 1, in order to make this structure clear, in the second layer, portions corresponding to each pixel in the layer are shown separately. As shown in FIG. 1, in the pixel regions of the first layer and the second layer which pixel regions are in contact with each other, both regions have hues which differ from each other. By having this structure, as shown in the diagram, it is possible to display the three colors red (R), blue (B) and green (G).

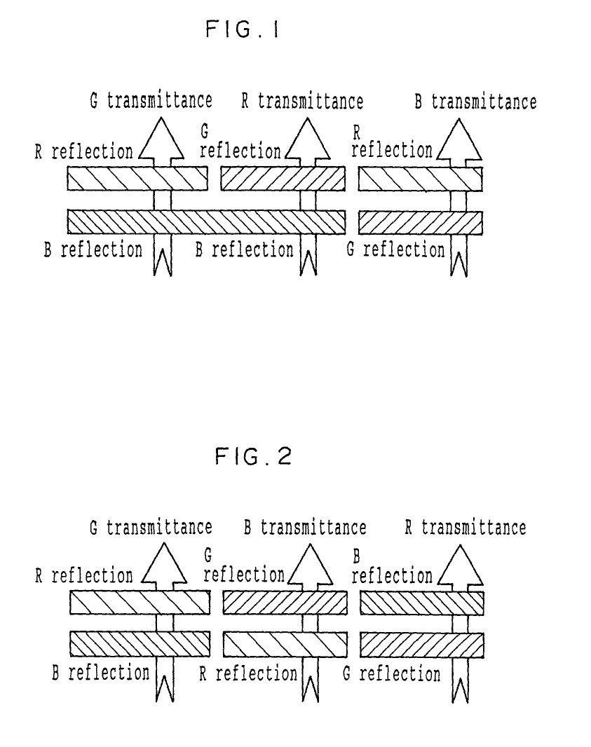

FIG. 2 is a cross-sectional diagram illustrating a schematic structure of a conventional two-layer color filter. As illustrated in the diagram, conventionally, it was necessary to form, pixels for of each of the colors R, G and B in both of the two layers, respectively. As a result, in the prior art, a complex step is necessary and then much of the costly cholesteric liquid crystal compound was lost.

The cholesteric liquid color crystal layer

In the present invention, the cholesteric liquid crystal layer includes a nematic liquid crystal compound and a chiral compound, and where necessary may further include, a polymerizable monomer, photopolymerization initiator, a binder resin, a surfactant, a thermal polymerization inhibitor, a thickener, a dye, a pigment, an ultraviolet light absorbant, a gelatinizer, a solvent and the like.

The nematic liquid crystal compound is one whose liquid crystal phase is fixed at or below the transition temperature of the crystal and is suitably selected from among, a liquid crystal compound whose refractive index ansiotrophy, Δn is 0.10-0.40, a macromolecular liquid crystal compound, and a polymerizable liquid crystal compound. At the time of melting, when the nematic crystal compound is in a liquid crystal state, it may be orientated by, for example, using an orientated substrate which has been exposed to an orientation process such as a rubbing process. It is then fixed by cooling as it is, and used as a solid phase.

The compounds below are given as specific examples of the nematic liquid crystal compound, but the present invention is not limited to these compounds.

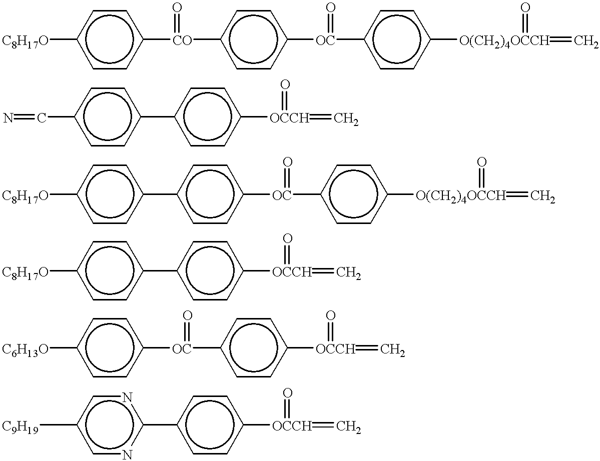

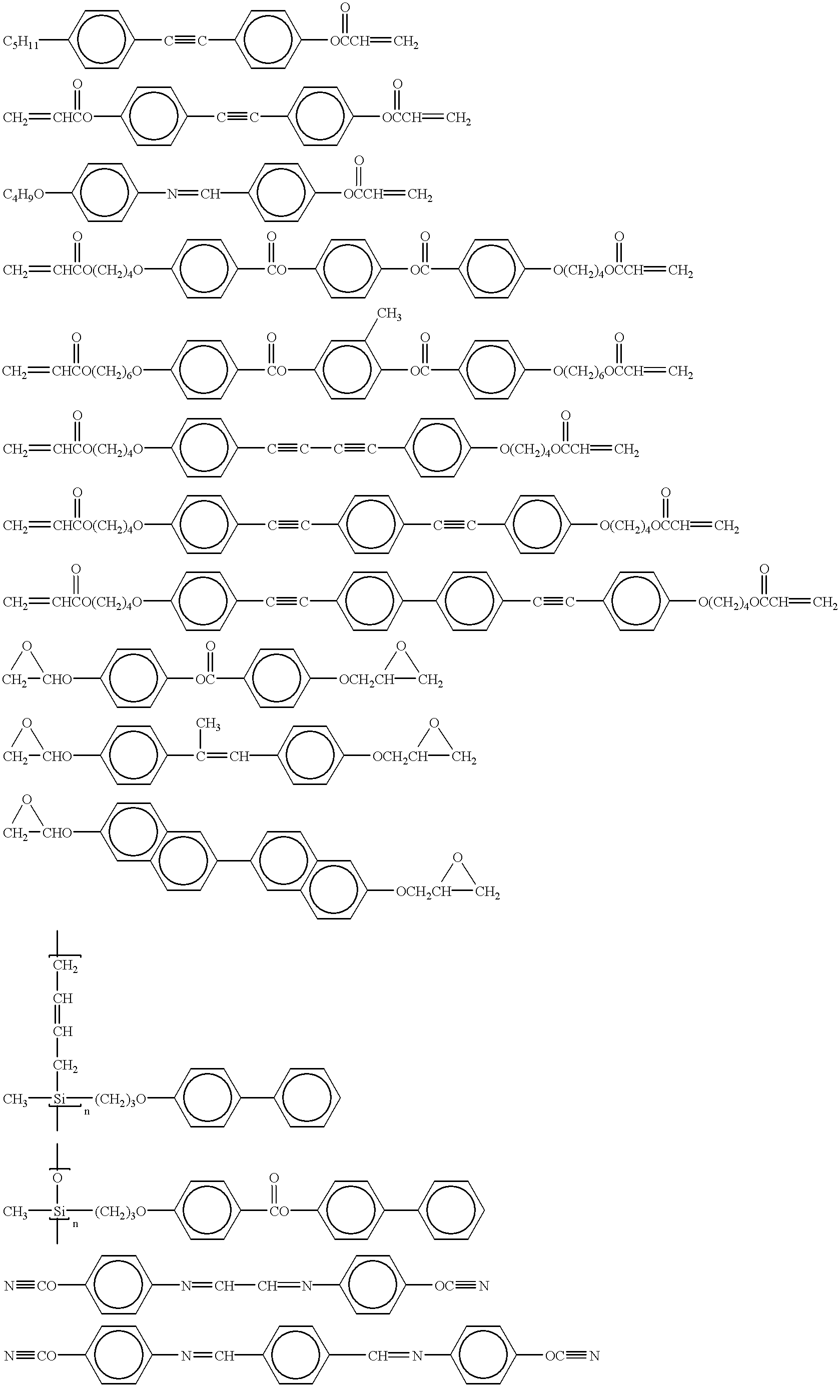

In the above formula, n represents an integer from 1 to 1000. The compounds may have structures which are the same as those of the above exemplary compounds except that side chain linking groups have the following structures.

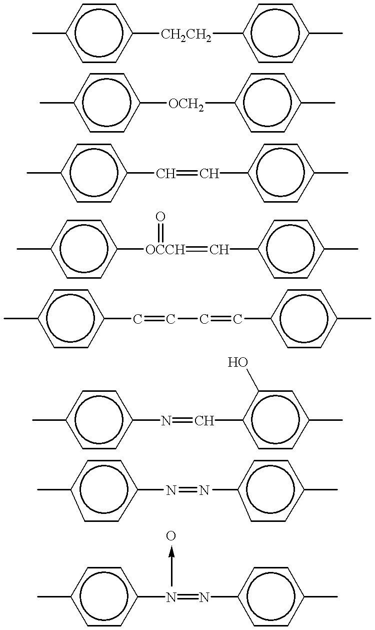

Of the above compounds, the nematic liquid crystal compound preferably is one having in the molecule a polymerizable group or a crosslinkable group, from the point of view of ensuring hardening ability and heat resistance.

The amount of the nematic liquid crystal compound included is preferably 30-98%, and more preferably 50-95%, of the total weight of the cholesteric liquid crystal layer. If the amount of the nematic liquid crystal compound included is less than 30% by weight, the orientation of the cholesteric liquid crystal composition may be insufficient.

The chiral compound used in the present invention is a photoreactive type chiral compound whose twist pitch of the cholesteric liquid crystal composition, is changed by light radiation (ultraviolet light-visible light- infra-red light). For this reason, the necessary molecular structural units are a chiral site, as well as a site in which structural change is caused by irradiation with light. A substance having these sites included in one molecule is preferable. As the chiral compound, non- photoreactive chiral compounds may be used with the photoreactive chiral compound.

The chiral compound is preferably one having a strong ability to induce a twisted structure in the cholesteric liquid crystal, thus it is preferable that the chiral site is at the center of the molecule and the periphery has a rigid structure. It is also preferable that the molecule weight thereof is equal to or greater than 300.

Further, in order to increase ability to induce the twisted structure, a substance in which a large degree of structural conversion is caused by light irradiation is used, and it is preferable that the chiral site and the site which causes structural conversion by light radiation are in close proximity. Also as the chiral compound which has a high solubility in the nematic liquid crystal, a substance having a SP value, which is a parameter of solubility, which is close to that of the nematic liquid crystal compound is preferable. Also, the heat resistance of the cholesteric liquid crystal layer is improved if at least one polymerizable bonding group is introduced in the structure of the chiral compound.

Examples of the structure of the reactive site which undergoes structural conversion due to light irradiation, include photochromic compounds (Kingo Uchida and Masahiro Irie, Chemical Industry Vol. 64, pg. 640,1999; Kingo Uchida and Masahiro Irie, Fine Chemicals Vol. 28 (9) Pg. 15, 1999). Concrete examples thereof are as follows.

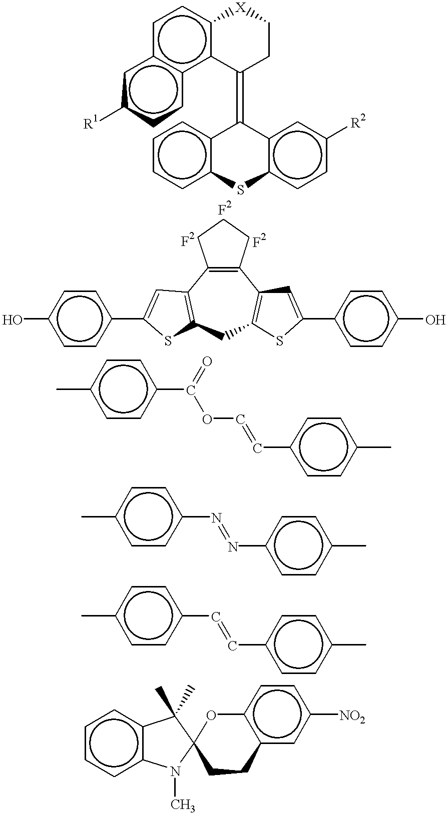

In the above formula, R¹ and R² may each represent an alkyl group, an alkoxyl group, alkenyl group, or an acryloyloxy group.

The chiral site may undergo a decomposition or addition reaction, isomerization, or a dimerization reaction by being irradiated with light, to thereby undergo irreversible structural change.

Further, the chiral site is, for example, an asymmetric carbon to which four different groups bond such as carbon atom of the compounds illustrated below where the symbol * represents. (Hiroyuki Nohira, Kagaku Sosetsu No. 22 Liquid Crystal Chemistry Pg. 73, 1994)

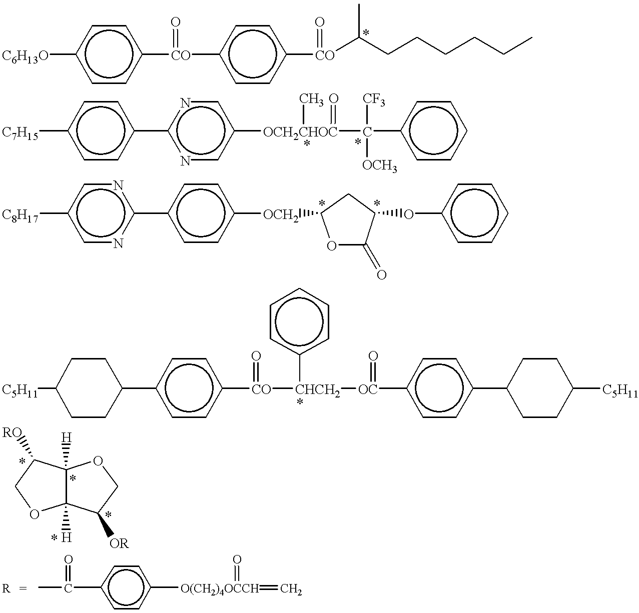

Further, the compound below is an example of the photoreactive chiral material which has both the chiral site and the photoisomerizable portion.

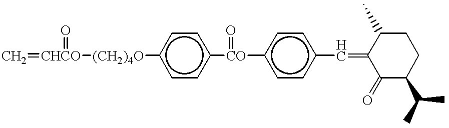

In the present invention, when the cholesteric liquid crystal layer is formed, the combinations of the nematic liquid crystals with these chiral compound can be selected so that the nematic liquid crystal composition has different twist pitches due to the differing radiation amounts and thus a desired hue. The two desired colors are formed in the first layer by selecting the two twist pitches for the first layer. Further the two desired colors are formed in the second layer in accordance with the same method so that one color of the first and second layers are the same and the remaining colors of these layers are different.

Further, in the present invention, as the chiral compound, the photoreactive chiral compound may be substituted by a compound whose helical twisting power has a large temperature dependency and whose twist pitch of a cholesteric liquid crystal composition, changes due to temperature. The relationship between the characteristics required in such a chiral compound having temperature dependency and the molecular structure of the compound is as follows:

1. The ability to induce a chain structure needs to be large, and thus the chiral site is positioned in the center of the molecule and the periphery is made a rigid structure. The molecule weight is preferably equal to or greater than 300.

2. The ability to induce the twisted structure due to temperature needs to be large, and thus it is preferable that there is a plurality of conformers in which the bonds which are close to the chiral site rotate.

3. The solubility of the chiral compound in the nematic liquid crystal compound needs to be large and thus the SP values, which is the parameter for the degree of solubility, of the nematic liquid crystal compound and of the chiral compound are preferably close.

4. Also, a structure in which one or more of the above polymerizable bonding groups is bonded, increases the heat resistance of the membrane and is therefore preferable.

The compounds below are examples of chiral compounds having characteristics.

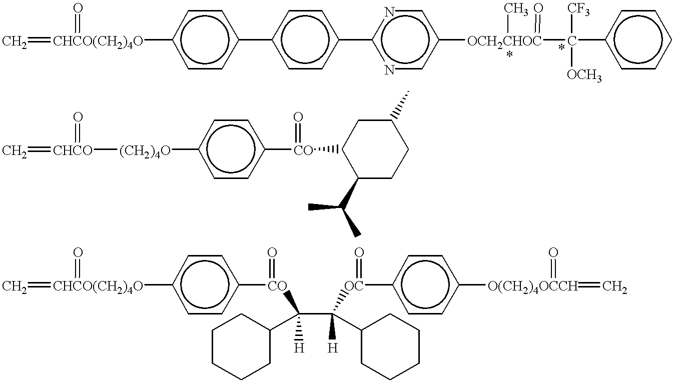

However, in the present invention, when the cholesteric liquid crystal layer is formed, a combination of nematic liquid crystal compounds and the temperature dependent chiral compounds is selected so that the cholesteric liquid crystal layer will change to a different twisted structure in accordance with different temperature conditions. In order to obtain the desired hue, the two desired colors are formed in the first layer. Further, in the second layer, as described before, the second layer has two colors, one of which is the same as one of the colors of the first layer and another of which is different from all of the colors of the first layer.

In order to form the cholesteric liquid crystal layer, a polymerizable monomer is used and examples thereof include the polymerizable monomers having an ethylenic unsaturated bond and the like such as multifunctional monomers (e.g. pentaerithritol tetraacrylate, dipentaerithritol hexaacrylate.)

The compounds below are specific examples of the monomers having ethylenic unsaturated bond. However, the present invention is not limited to these examples.

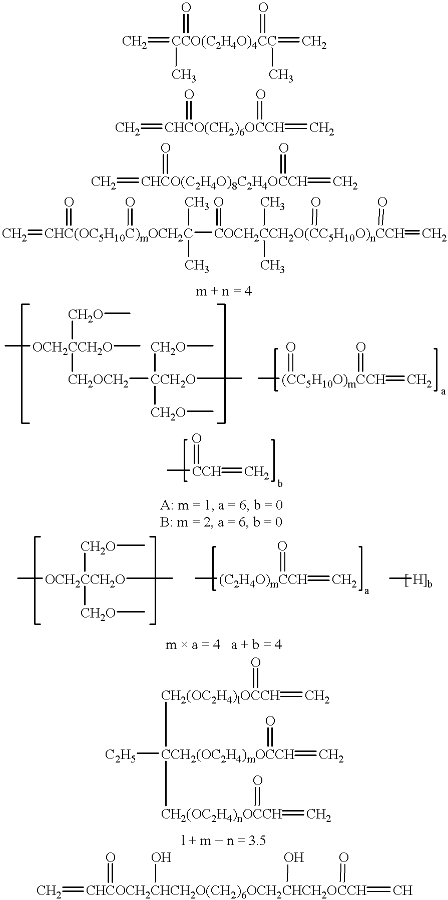

The amount of the above polymerizable monomer to be added is preferably 0.5-50% of the weight of the total solid content of the cholesteric liquid crystal layer. If the amount of the polymerizable monomer added is less than 0.5% by weight, it may not be possible to obtain sufficient hardening, while if the amount added exceeds 50% by weight, the orientation of the liquid crystal molecules will be hindered and sufficient color density will not be obtained.

In addition, after the cholesteric liquid crystal layer is transferred, the twist pitch of the liquid crystal molecules in the cholesteric liquid crystal layer which has been formed on the substrate is fixed. Further, in order to increase the membrane strength of the cholesteric liquid crystal layer, a photopolymerization initiator may be added to the cholesteric liquid crystal layer.

The photopolymerization initiator may be suitably chosen from known photopolymerization initiators and examples include p-methoxyphenyl-2, 4-bis (trichloromethyl)-s-triazine,2-(p-butoxystyryl)-5-trichloromethyl-1,3,4-oxydiazole, 9-phenylacridine, 9,10-dimethyl benzphenazine, benzophenone/Michler's ketone, hexaarylbiimiadazole/mercaptobenzimidazole, benzyl dimethyl ketal, thioxanthone/amine, and the like.

The amount of the photopolymerization initiator to be used is preferably 0.1 to 20%, and more preferably 0.5 to 5%, of the total solid content by weight of the cholesteric liquid crystal layer. When the amount is less than 0.1% by weight, the efficiency of the hardening when the light is irradiated is low, and as a result, the hardening takes a long time. If the amount of the photopolymerization initiator exceeds 20% by weight, the light transmittance from the ultraviolet light region to the visible light region may be poor.

Examples of the binder resin include polystyrene compounds such as polystyrene, poly-α-methylstyrene and the like, cellulose resins such as methyl cellulose, ethyl cellulose, acetyl cellulose and the like, an acidic cellulose derivative having a carboxyl group in a side chain, an acetal resin such as polyvinyl formal, polyvinyl butyral and the like, metacrylic acid copolymers, acrylic acid copolymers, itaconic acid copolymers, crotonic acid copolymers, maleic acid copolymers, partially esterified maleic acid copolymers and the like, disclosed in Japanese Patent Application Laid-Open No. 59-44615, Japanese Patent Application Publication Nos. 54-34327, 58-12577, 54-25957, Japanese Patent Application Laid-Open Nos. 59-53836 and 59-71048.

Examples of the binder resin may also include a homopolymer of alkyl acrylate and alkyl metacrylate. Examples of those alkyl groups include a methyl group, an ethyl group, an n-propyl group, an n-butyl group, an isobutyl group, an n-hexyl group, a cyclohexyl group, 2-ethyl-hexyl group, and the like.

Other examples of the resin binder include a substance in which an acid anhydride is added to a polymer having an hydroxyl group, benzyl (meta) acrylate/(homopolymer of metacrylic acid), acrylic acid copolymer or benzyl (meta) acrylate/ (meta) acrylic acid/other monomer copolymers and the like.

The amount of the binder to be included is preferably 0-50%, and more preferably 0-30% by weight, of the total solid content of the cholesteric liquid crystal layer. If the amount exceeds 50% by weight, the orientation of the nematic liquid crystal compound may be insufficient.

Further, in order to increase preservability, a polymerization inhibitor may be added. Examples of the polymerization inhibitor include hydroquinone, hydroquinone monomethyl ether, phenothiazine, benzoquinone and derivatives of these. The amount of the polymerization inhibitor to be added is preferably 0 -10% by weight, and more preferably 0-5% by weight based on the polymerizable compound.

The above components are dissolved in an appropriate solvent and the solution is prepared. A cholesteric liquid crystal layer is formed by using a desired coating method to coat this solution onto a support or onto a temporary support.

The cholesteric liquid crystal color filter of the present invention may be manufactured by a known method. That is to say, as described above, in the case where the cholesteric liquid crystal composition which forms the cholesteric liquid crystal layer includes a photoreactive type chiral compound, after the cholesteric liquid crystal layer is formed from the cholesteric liquid crystal composition, light is irradiated onto the cholesteric liquid crystal layer, through a photo-mask in which a transmittance portion and a shield portion are disposed, to thereby pattern the cholesteric liquid crystal layer into two colors. Further, a second light is irradiated on the entire surface, and thus the twist pitch is fixed and the first cholesteric liquid crystal layer is formed. The second liquid crystal layer is formed by a process similar to that above and a cholesteric liquid crystal layer color filter having two cholesteric liquid crystal layers is obtained.

Further, when the cholesteric liquid crystal composition which forms the cholesteric liquid crystal layer includes a chiral compound having a helical twisting power (HTP) with a large temperature dependency, after the cholesteric liquid crystal layer is formed from the cholesteric liquid crystal composition, the cholesteric liquid crystal layer is irradiated with light through a photo-mask having a transmittance portion and a shield portion at a first temperature. As a result, the color of the light irradiation region is fixed and next, at a second temperature, light is irradiated through a photo-mask, partially or onto the entire surface, to thereby fix a second color and the first cholesteric liquid crystal layer is formed. In the case of the formation of the second cholesteric liquid crystal layer, a process like the one above is carried out in accordance with the desired hue to thereby form the second cholesteric liquid crystal layer.

Even in the case when the above chiral compounds are used, it is preferable that the total area of each of the colors are different in the first and second cholesteric liquid crystal layers. That is to say, in the case of the color filter in which the area of each pixel is uniform and full color (R, G, &B) display is possible, and the total area for the R color pixels, the total area for the G color pixels, and the total area for the B color pixels are the same, it is necessary for each of the colors in each of the layers to be different from each other. More specifically, for example, as shown in FIG. 1, in the first cholesteric liquid crystal layer, the total area of the regions which reflect blue light (B reflection region) is ⅔ of the total area of the layer and the total area of the regions which reflect green light (G reflection region) is ⅓ of the total area of the layer. In the second cholesteric liquid crystal layer, the regions which reflects red light (R reflection region) correspond to half of the B reflection regions of the first cholesteric liquid crystal layer and to the G reflection region of the first cholesteric liquid crystal layer. The G reflection region of the second cholesteric liquid crystal layer corresponds to the remaining B reflection region of the first cholesteric liquid crystal layer. As a result, regions which transmit green light (G transmission region) and to which laminations of the R reflection region and the B reflection region correspond, the regions which transmit red light ( R transmission region) and to which laminations of the G reflection region and the B reflection region correspond, and the regions which transmit blue light (B reflection region) and to which laminations of R reflections and G reflection regions correspond, each have an area which is ⅓ of the total area and thus the total area of each of the R, G and B pixels is uniform. The total area of each of the two regions whose colors are different of either of the liquid crystal layers is identical. That is to say, if regions whose colors are different of either of the liquid crystal layers had an area of ½ of the total area of the layer, then it would not be possible to form three types of pixels each having the same total areas. In the case of a display device which does not display intentionally full color images, each of the three types of pixels in each of the liquid crystal layers may be the same.

Hereinafter, a brief explanation will be given of the manufacturing method for the cholesteric liquid crystal color filter of the present invention in accordance with the steps.

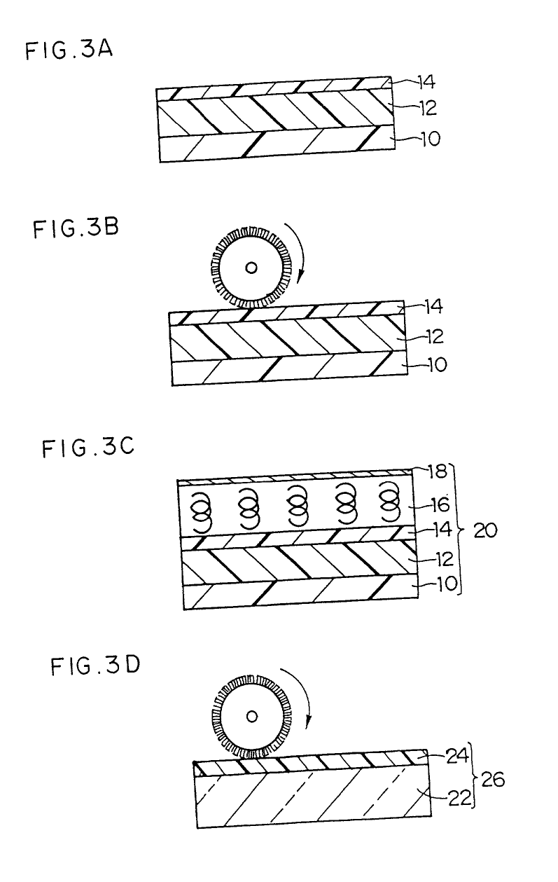

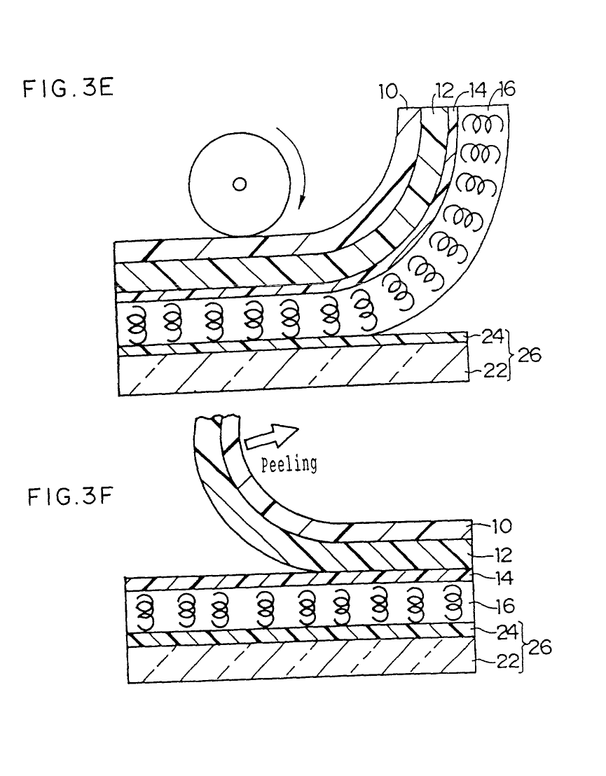

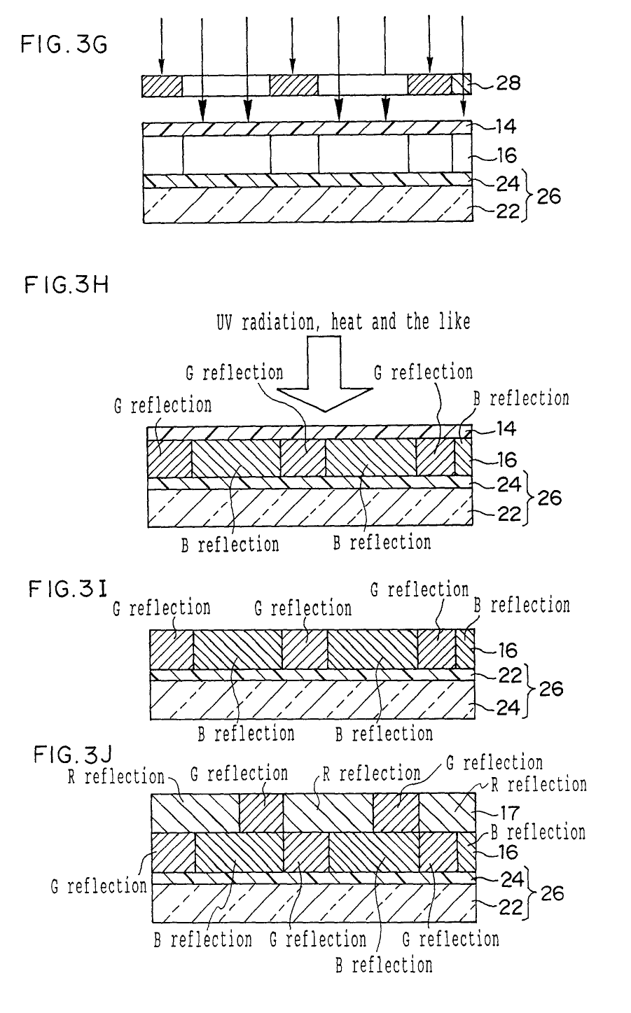

FIG. 3 is a process diagram which illustrates an embodiment of the present invention. In FIG. 3A, on a support 10 (referred to as a temporary support), an orientation membrane 14 is formed with the cushion layer 12 in between. As shown in FIG. 3B, this orientation membrane is subjected to a rubbing process. This rubbing process does not necessarily need to be performed, but orientation is enhanced by the rubbing process. Next, as shown in FIG. 3C, on top of the orientation membrane 14, a first cholesteric liquid crystal layer 16 is formed and then a cover film 18 is provided on the first cholesteric liquid crystal layer 16. The sheet thus obtain is hereinafter referred to as the transfer sheet 20.

On the other hand, as shown in FIG. 3D, on the support 22, the orientation membrane 24 is formed and subjected to a rubbing process. The substrate obtained as a result of this process is referred to as the substrate 26 for a color filter.

Next, as illustrated in FIG. 3E, after the cover film 18 is removed, the transfer sheet 20 is laminated to the substrate 26 by being rolled, so that the orientation membrane 24 of the substrate 26 for the color filter is in contact with the first cholesteric liquid crystal layer 16 of the transfer sheet 20. Subsequently, as shown in FIG. 3F, removal is carried out between the orientation membrane and the cushion layer 12 of the transfer sheet 20.

At this time, in a case where the photoreactive chiral compound is used, as shown in FIG. 3G, a mask 28 is disposed on the orientation membrane 14. The mask 28 has a plurality of regions whose light transmission amounts differ (two pattern regions in the present embodiment). Light is irradiated onto the cholesteric liquid crystal layer 16 through the mask 28. The cholesteric liquid crystal layer 16 comprises, a cholesteric liquid crystal compound, a chiral compound and the like so that the twist pitch can vary in accordance with the light radiation amount. The first cholesteric liquid crystal layer has two types of regions whose radiation amounts differ, and twist pitches differ in respective regions and the two types of regions have a different hue in accordance with the twist pitch thereof. In the present embodiment, the composition of the first cholesteric liquid crystal layer is such that the regions which reflect green light (G reflection) and transmit blue light and red light, and the regions which reflect blue light (B reflection) and transmit green light and red light are formed.

Next, as illustrated in FIG. 3H, the pattern of the first cholesteric liquid crystal layer is fixed by a means for irradiating light of a wavelength which differs from that of the light used in FIG. 3G, or by a heating means. Subsequently, the cushion layer 14 on the cholesteric liquid crystal layer 16, is removed. As illustrated in FIG. 31, the first cholesteric liquid crystal layer having green (G) or blue (B) reflection regions is obtained. Subsequently, the second cholesteric liquid crystal layer is formed by a process like the one described above. However, as illustrated in FIG. 3J, G reflection regions and R reflection regions are formed in the second cholesteric liquid crystal layer 17 so that, in each pixel, the colors of the first and second cholesteric liquid crystal layers differ, and are fixed in the same manner as the formation process of the first cholesteric liquid crystal layer 17, and a two-layer cholesteric color filter is thereby formed.

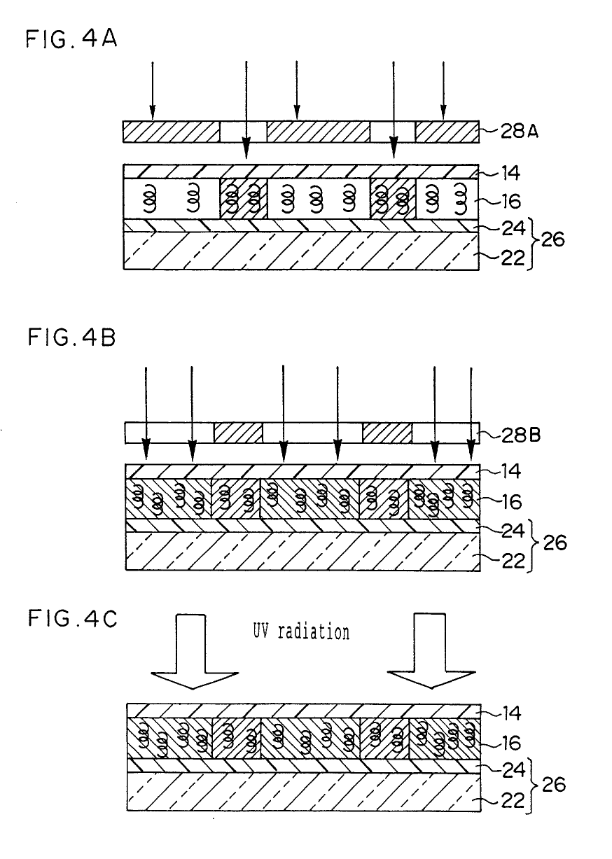

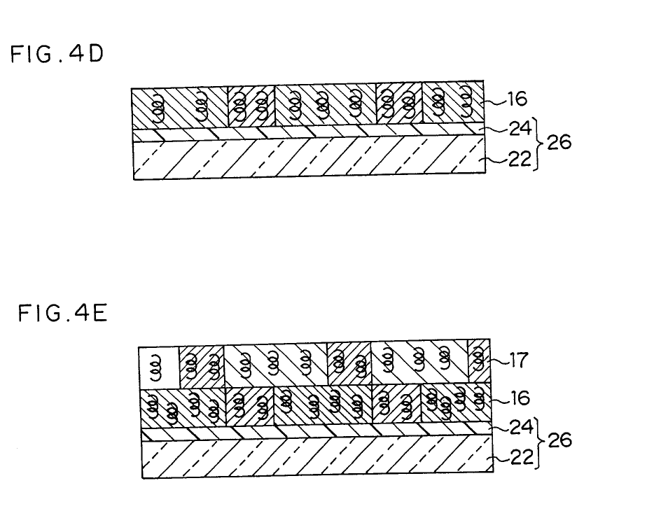

In the case where the cholesteric liquid crystal composition which forms the cholesteric liquid crystal layer includes a chiral compound whose helical twisting power (HTP) has a large temperature dependency, the steps shown in FIGS. 3A through to 3F are the same. However, as shown in FIG. 4A, the mask 28A is disposed on top of the orientation membrane 14 and cholesteric liquid crystal layer 16 is heated to a predetermined temperature (temperature 1). The of twist pitch structure of the cholesteric liquid crystal composition then changes and at the temperature, active light rays are irradiated onto the cholesteric liquid crystal layer 16 through the mask 28A and the irradiated region of the cholesteric liquid crystal composition is photopolymerized or else crosslinked to form the first pattern.

As illustrated in FIG. 4B, a mask 28B which is different from the mask 28A, is disposed on the top of the orientation membrane 14. The cholesteric liquid crystal layer 16 is heated to a predetermined temperature (temperature 2) which differs from temperature 1. Thus the twist pitch structure of the cholesteric liquid crystal composition changes in the non-exposed regions. At this temperature, the cholesteric liquid crystal layer 16 is irradiated with active light rays in a region different from that in FIG. 4A. A cholesteric liquid crystal composition in radiation regions, is photopolymerized, or else crosslinked to form a second pattern having a hue which is different from that of the first pattern. The mask 28B which is used when this second pattern is formed, has a formation pattern which is the inverse of that of the mask 28A used in the formation of the first pattern. The active light rays are radiated at regions other than the radiation regions of the active light rays used in the formation of the first pattern.

Next, as illustrated in FIG. 4C, the entire surface of the cholesteric liquid crystal layer 16 is heated to a predetermined temperature (temperature 3) which is different from the temperatures used in the formation of the first and second patterns, or else the cholesteric liquid crystal layer is polymerized or crosslinked by irradiating the entire surface of the cholesteric liquid crystal layer 16 with active light rays under the increased temperature conditions. Thus, the first cholesteric liquid crystal layer is fixed. Subsequently, as illustrated in FIG. 4D, the unnecessary portions on the cholesteric liquid crystal layer 16 are removed by washing or dissolution and the cholesteric liquid crystal layer 16 thereby appears. Further, as illustrated in FIG. 4E, the second cholesteric liquid crystal layer is formed, irradiated and fixed in the same manner as the formation step of the cholesteric liquid crystal layer 16, so that in each pixel, the colors of the first and second cholesteric liquid crystal layers differ and so that one of the two colors of the second cholesteric liquid crystal layer differs from the two colors of the first cholesteric liquid crystal layer. In the present embodiment, the second cholesteric liquid crystal layer 17 has green (G) reflection regions and a red (R) relection regions.

The above methods which are illustrated by FIGS. 3 and 4 are embodiments of the manufacturing method of a color filter using the laminating method. However, the present invention includes an unillustrated color filter manufacturing method which uses a coating method.

In the color filter manufacturing method which uses the coating method, on the orientation membrane 24 of the color filter substrate 26, in which the orientation membrane 24 was disposed on the color filter substrate 22 in FIG. 3D, a cholesteric liquid crystal layer is formed using a coating method. Subsequently, steps shown in FIGS. 3G to 3J or steps shown in FIGS. 4A to 4E are sequentially carried out. Details of these steps and the materials such as the support used are described in Japanese Patent Application No. 11-342896 and No. 11-343665 which were previously filed by the inventors of the present invention.

Next a display device for using the cholesteric liquid crystal filter of the present invention will be described. FIG. 5 is a schematic structural diagram of a transmission type LCD which is an example of the display device.

Transmission type LCD 801 includes a light source 802 chosen from a florescent tube or a flat florescent lamp which are structured to radiate white light composed of three wavelength bands each having a width of approximately 20 nm. The three wavelength bands are the red wavelength band whose center is approximately 610 nm, the green wavelength band whose center is approximately 540 nm and the blue wavelength band whose center is approximately 450 nm. In order for the light radiated from the light source 802 to be conducted to the liquid crystal display device, a reflection plate 803 is provided in front of the light source 802. Next the light is entered into the reflection circular polarizing plate 805 through the collimeter 804. The reflection circular polarizing plate 805 is a straight polarizing plate which absorbs specific polarized light and transmits light which is orthogonal to the polarized light.

Further, the glass plate 806 is laminated onto the reflection circular polarizing plate 805 and the two-layer cholesteric liquid crystal color filter 807 of the present invention is formed on top of the glass plate 806.

On the color filter 807, a quarter wavelength plate, λ/4 plate 808 which converts the entered surface polarized light to circularly polarized light is provided. Since the light which is irradiated onto λ/4 plate 808, has been linearly polarized, the circularly polarized light transmitted by the λ/4 plate are all circularly polarized in the same direction. For example they all may be polarized in the anti-clockwise direction.

On the λ/4 plate 808, the liquid crystal layer 809 and the glass plate 810 are sequentially disposed. On the uppermost layer, the black screen 812 having the polarized substrate 811 is disposed.

In the case where the liquid crystal color filter 807 of the present invention is incorporated into this type of display device, the light which is reflected in each region of the color filter 807 passes through an optical member which is composed of a back light unit. For example, the light may be reflected again at a reflection plate 803, or it may be passed through a region of a color filter which region is of another color, and thus there is an advantage that efficiency in the use of light may be increased.

Further, by incorporating the collimeter 804 which is the same as the above-described object, the change in hue due to the angle at the time of viewing is suppressed and therefore, the range of color reproduction is considerably increased. In this case increasing the angle at the time of viewing can be sufficiently carried out using the black screen 812, resulting in a display device more suited for practical use.

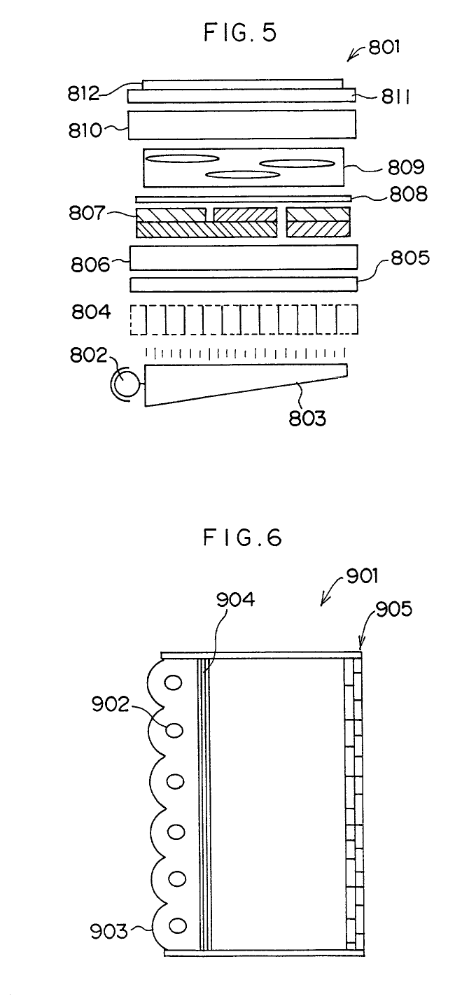

FIG. 6 is a cross-section illustrating another embodiment of the display using the cholesteric liquid crystal color filter of the present invention.

The display device 901 is provided with a light source 902 which is structured so as to output white light composed of three wavelength bands each having a width of approximately 20 nm. The three wavelength bands are the red wavelength band whose center is approximately 610 nm, the green wavelength band whose center is approximately 540 nm and the blue wavelength band whose center is approximately 450 nm. In order for the light radiated from the light source 902 to be conducted to the liquid crystal display device, a reflection plate 903 is provided behind the light source 902. Next the light is entered into the reflection circular polarizing plate 904. The reflection circular polarizing plate 904 includes a linearly polarizing plate which absorbs specific polarized light and transmits light which is orthogonal to the polarized light, and a λ/4 plate which converts surface polarized light incident on circularly polarized light. Since the light which is irradiated onto λ/4 plate, has been linearly polarized, the circularly polarized light transmitted by the λ/4 plate are all circularly polarized in the same direction. For example they all may be polarized in the anti-clockwise direction.

The circularly polarized light which has been passed through the circular polarizing plate is irradiated onto the cholesteric liquid crystal filter 905 which includes the first cholesteric liquid crystal layer and the second cholesteric liquid crystal layer. The cholesteric liquid crystal layer is preferably provided between the substrates of the liquid crystal display device. The first liquid crystal layer and the second liquid crystal layer respectively, depending on the combination of the two layers of the pixel region, has a cholesteric liquid crystal layer polymer membrane which is patterned so as to have regions which reflect red light and transmit blue and green light, regions which reflect blue light and transmit red and green light, and regions which reflect green light and transmit red and blue light. As illustrated in FIG. 1, each region of the first liquid crystal layer, is positioned with each region of the second liquid crystal layer such that they have light of different hues. As a result, for example, the light which is transmitted by the first liquid crystal layer, in the second liquid crystal layer, is incident on regions which reflect green light and transmit only blue light and red light and regions which reflect red light and transmit only blue light and green light. Each region of the filter 905 transmits only one of the three wavelengths and reflects the other two wavelengths and the filter 905 can thereby display a full color image.

### EXAMPLES

A detailed description of the present invention will be given using the examples described below. However the present invention is not limited to these examples.

### Example 1

### Manufacturing of the photosensitive transfer materials

A polyethylene terephthalate base film which is subjected to a rubbing process and has a thickness of 75 μm was prepared as the temporary support. As the photosensitive resin layer coating solution, the respective coating solutions prepared using the formulae A and B were coated onto the support by a spin coater, and dried in an oven at 100° C. for 2 minutes to thereby form the photosensitive resin layer. As the cover film, a polypropylene film of a thickness of 2 μm was laminated onto the photosensitive resin layer and the photosensitive transfer material was thereby obtained.

Formula A for coating solution for photosensitive resin layer

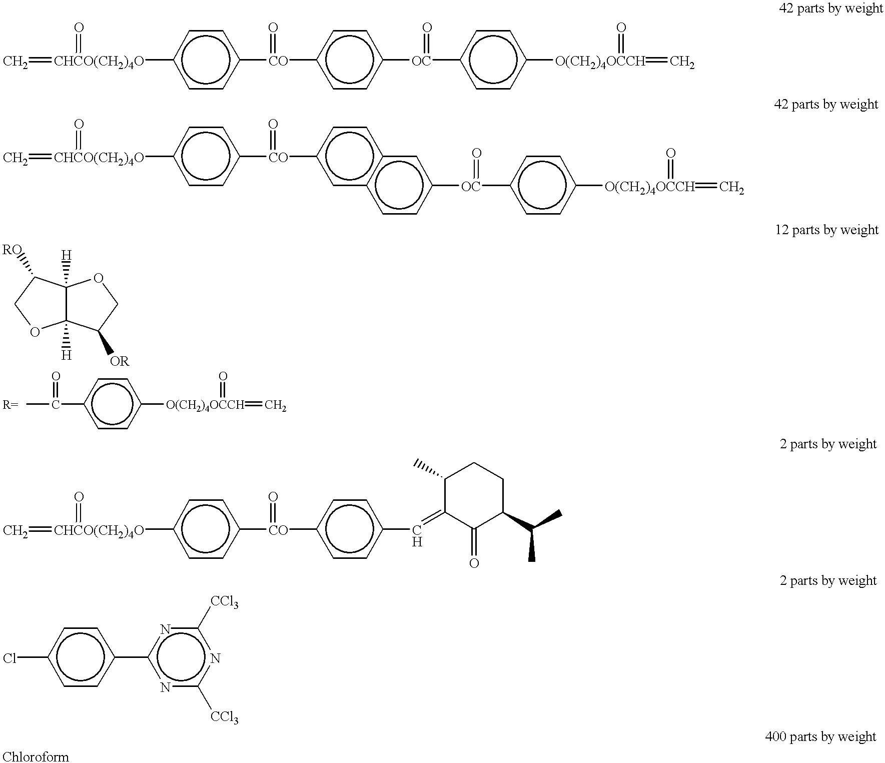

Formula B for coating solution for photosensitive resin layer

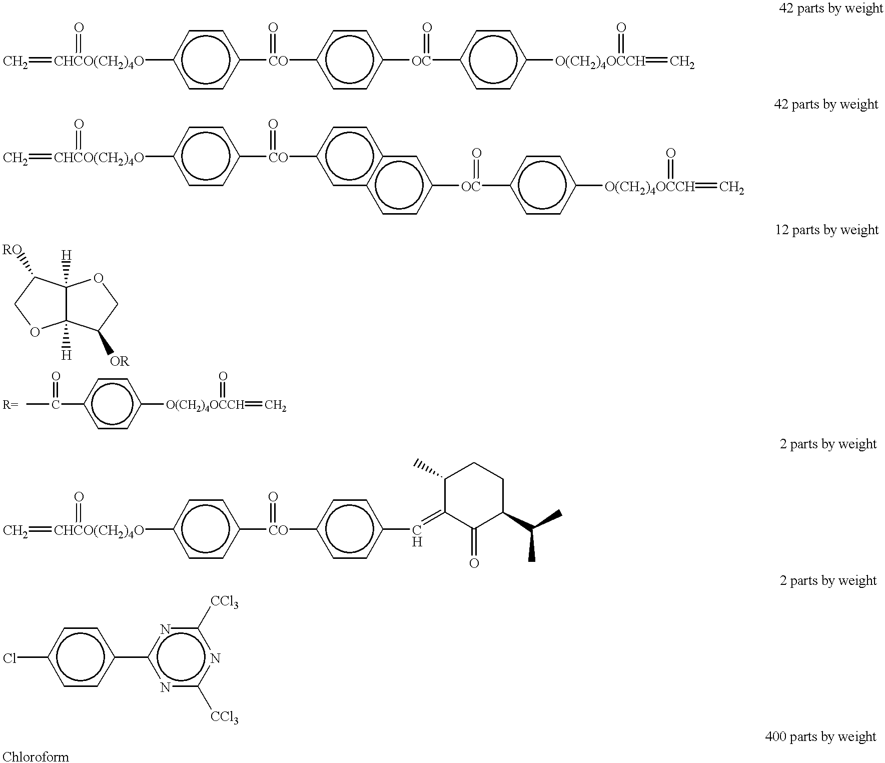

### Manufacturing of the color filter

The manufacturing method for the color filter will be described below.

1. Preparation of the filter substrate

A polyimide orientation membrane coating solution was coated on a glass substrate by a spin coater. After being dried in an oven at 100° C. for 5 minutes, it was baked in an oven at 250° C. for 1 hour to thereby provide the orientation membrane. In addition, the surface of the membrane was subjected to the orientation process by rubbing to thereby obtain the glass substrate having an orientation membrane.

2. Formation of the filter layer (the first liquid crystal layer)

The cover film was removed from the photosensitive transfer sheet formed using the coating solution of formula A.

The orientation membrane surface on the glass substrate and the photosensitive resin layer of the photosensitive transfer sheet were superposed and adhered using a laminator (Fast laminator 8B-550-80 manufactured by Taisei Laminator Co. Ltd.), with an applied pressure of 2 kg/m², a roller temperature of 130° C. and a speed of 2 m/min.

The glass substrate with the photosensitive transfer sheet adhered thereto was kept at a temperature of 110° C. for 5 minutes on a hot plate. The photosensitive resin layer was color developed and then exposed using a super high pressure mercury lamp. The exposure was carried out through a photo-mask which was set such that the ratio of the area of the shading regions for the blue pixel and the area of the opening portion region for the green pixel was 2: 1, and through a band pass filter whose center wavelength was 365 nm. The radiation energy was 500 J/cm².

Next, the photo-mask and the band pass filter were removed and while carrying out a nitrogen purge, all of the surface was exposed using the same super high pressure mercury lamp to polymerize the layer. Further, to promote hardening the filter portion, it was baked in an oven of 220° C. for 10 minutes and a substrate for a color filter having green pixel and blue pixel patterns was obtained.

3. Formation of filter layer (second liquid crystal layer)

The surface of the color filter substrate obtained in the previous step was subjected to orientation processing by rubbing and the cover film was removed from the photosensitive transfer sheet which was formed using formula B. The color filter surface on the substrate for color filter and the photosensitive resin layer of the photosensitive transfer sheet were superposed and adhered using a laminator (Fast laminator 8B-550-80 manufactured by Taisei Laminator Co. Ltd.), with an applied pressure of 2 kg/m², a roller temperature of 130° C. and a speed of 2 m/min.

Next, the glass substrate with the photosensitive transfer sheet adhered thereto was kept at a temperature of 110° C. for 5 minutes on a hot plate. The photosensitive resin layer was color developed and then exposed using a high pressure liquid silver lamp. The exposure was carried out through a photo-mask which was set such that the ratio of the area of the shading regions for the green pixels and the area of the opening portion regions for the red pixels was 2: 1, and through a band pass filter which transmitted light having a center wavelength of 365 nm. The radiation energy was 500J/cm².

Next, the photo-mask and the band pass filter were removed and while a nitrogen purge was carried out, all of the surface was exposed using the same super high pressure mercury lamp to polymerize the layer. Further, in order to promote hardening of the filter portion, it was baked in an oven at 220° C. for 10 minutes, and a second layer having green and blue pixel patterns was obtained.

The arrangement of each of the pixels for the first layer and the second layer of the cholesteric color filter obtained in this manner, was the same as is illustrated in FIG. 1. The obtained color filters were observed with transmitted light which was circularly polarized in the clockwise direction and was confirmed to be a color filter in which each of the colors R,G, and B was arranged.

### Example 2

### Manufacturing of the photosensitive transfer material

A coating solution, which serves as a coating solution for a thermoplastic resin, was prepared using the formula below, and coated on a polyethylene terephthalate base film having a thickness of 75 μm which serves as a temporary support, using a spin coater. The coated layer was then dried in an oven at 100° C. for 2 minutes and a thermoplastic resin layer having a thickness of 15 μm was thereby obtained.

Formula of a coating solution for a thermoplastic resin layer

| | |
|---|---|
| styrene/acrylic acid copolymer | 15 parts by weight |
| (copolymerization ratio 60:40 weight-average | |
| molecular weight 8000) | |
| 2-2-bis-(4-(metacryloxypolyethoxy) | 7 parts by weight |
| phenylpropane) | |
| fluorine-containing surfactant | 1.5 parts by weight |
| (F-176PF manufactured by Dainippon Ink) | |
| propylene glycol monomethyl ether | 28 parts by weight |
| methyl ethyl ketone | 27 parts by weight |

Next, on the thermoplastic resin layer, a coating solution prepared using the formula below, which serves as a coating solution for the intermediate layer, was coated using a spin coater and then dried in an oven for two minutes at 100° C. to thereby form an intermediate layer of a thickness of 1.6 μm on top of the thermoplastic resin layer. Further, the intermediate layer was subjected to a rubbing process using a nylon cloth.

Formula of a coating solution for an intermediate layer

| | |
|---|---|
| polyvinyl alcohol | 15 parts by weight |
| (PVA 205 manufactured by Kuraray Co., Ltd.) | |
| polyvinylperoridon | 6 parts by weight |
| (PVP-K30 manufactured by Gokyo Industries) | |
| methanol | 173 parts by weight |
| ion-exchanged water | 211 parts by weight |

Subsequently, each of the coating solutions prepared by the same formulae as in example 1, and serving as the coating solutions for the photosensitive resin layer, was then coated using a spin coater then dried in an oven at a temperature of 100° C. for 2 minutes to thereby form photosensitive resin layer. As a cover film, a polypropylene film of a thickness of 12 μm was laminated at room temperature onto the photosensitive resin layer, and photosensitive transfer layer in which a thermoplastic resin layer, an intermediate layer and a photosensitive resin layer were laminated to a base film in that order was obtained.

A method of manufacturing a color filter will be described.

1. Preparation of the filter substrate

A polyimide acid orientation membrane solution is coated onto a glass substrate using a spin coater, then dried in an oven at a temperature of 100° C. for 5 minutes and subsequently baked in an oven at a temperature of 250° C. for 1 hour to thereby provide orientation membrane 1. Further, the membrane surface was subjected to an orientation process by rubbing and a glass substrate having an orientation membrane was obtained.

2. Formation of a filter layer (first liquid crystal layer)

The cover film was removed from the photosensitive transfer sheet which was formed using the coating solution formula A, and the orientation membrane surface on the glass substrate and the photosensitive resin layer of the photosensitive transfer sheet were superposed and then adhered using a laminator (Fast Laminator 8B-550-80 manufactured by Taisei Laminator) with an applied pressure of 2 kg/m², a roller temperature of 130° C. and a speed of 0.2 m/min.

Then, the polyethylene terephthalate temporary support was removed from the thermoplastic resin layer. The glass substrate was then kept at a temperature of 110° C. on a hot plate for 5 minutes to thereby color develop the photosensitive resin layer. The exposure was carried out by a super high pressure mercury lamp through a photo-mask which was set such that the ratio of the area of the shading regions for the blue pixels and the area of the opening regions for the green pixels was 2: 1, and through a band pass which transmitted light having a center wavelength of 365 nm. The radiation energy was 500 mJ/cm².

Next, the photo-mask and the band pass filter were removed, and while carrying out a nitrogen purge, the entire surface was exposed (500 mJ/cm²) using the same super high pressure mercury lamp and polymerization hardening was carried out. Incidentally, a predetermined processing solution (T-PD2, manufactured by Fuji Photo Film Co., Ltd.) was used to remove the thermoplastic resin layer and the intermediate layer. Further, in order to promote the hardening of the filter portion, it was baked at 220° C. for 10 minutes in an oven and a color filter substrate having green and red pixel patterns was obtained.

3. Formation of a filter layer (second liquid crystal layer)

The surface of the color filter substrate obtained in the previous step was subjected to an orientation process by rubbing, and the cover film was removed from the photosensitive transfer sheet formed by using the coating solution formula B. The color filter surface on the substrate for color filter and the photosensitive resin layer of the photosensitive transfer sheet were superposed and then adhered using a laminator (Fast Laminator 8B-550-80 manufactured by Taisei Laminator) with 2 kg/m² of applied pressure, a roller temperature of 130° C. and a speed of 0.2 m/min.

Next, the polyethylene terephthalate temporary support was removed from the thermoplastic resin layer. The glass substrate was then kept at a temperature of 110° C. on a hot plate for 5 minutes to thereby color develop the photosensitive resin layer. The exposure was carried by a super high pressure mercury lamp, through a photo-mask which was set such that the ratio of the area of the shading regions for the green pixels and the area of the opening regions for the red pixels was 1: 2, and through a band pass filter which transmitted light having a center wavelength of 365 nm. The radiation energy was 500 mJ/cm².

Next, the photo-mask and the band pass filter were removed, the total surface was exposed while carrying out a nitrogen purge using the same super high pressure mercury lamp and polymerization hardening was carried out. Incidentally, a predetermined processing solution (T-PD2, manufactured by Fuji Photo Film Co., Ltd.) was used to remove the thermoplastic resin layer and the intermediate layer. Further, the layer was baked at 220° C. for 10 minutes in an oven in order to promote hardening and a color filter having a second layer of green and red pixel patterns was thereby obtained.

The arrangement of each of the pixels for the first layer and the second layer of the cholesteric color filter thus obtained, was as illustrated in FIG. 1. When the filter was observed with transmission light which was polarized in the clockwise direction, it was confirmed that the color filter had each of the colors R, G & B arranged therein.

What is claimed is:

1. A cholesteric liquid crystal color filter comprising:
(a) a first cholesteric liquid crystal layer having a first region of a first color and a second region of a second color; and
(b) a second cholesteric liquid crystal layer having a first region of a color the same as or similar to the second color, and a second region of a third color, with the first region of the second layer and the second region of the second layer formed on the first region of the first layer, and the second region of the second layer formed on the second region of the first layer.

2. The cholesteric liquid crystal color filter of claim 1, wherein total area of the first and second regions of the first layer differ from one another, and total area of the second regions together in the second layer differs from total area of the first region in the second layer.

3. The cholesteric liquid crystal color filter of claim 2, wherein a ratio of the total area of the first region in the first layer to the total area of the second region in the first layer, is substantially 2:1, and a ratio of the total area of the first region in the second layer to the total area of the second regions together in the second layer, is substantially 1:2.

4. The cholesteric liquid crystal color filter of claim 1, wherein the first color is selected from the group of colors consisting essentially of red, blue and green, and the second color is selected from one of the other two remaining colors of the group after the first color has been selected, and the third color is the remaining color after the first color and the second color are selected.

5. A method for manufacturing a cholesteric liquid color filter comprising the steps of:
(a) forming a first cholesteric liquid crystal layer using a cholesteric liquid crystal composition having a photoreactive chiral compound;
(b) forming a pattern in the first cholesteric liquid crystal layer by radiating light through a photo-mask, with the pattern having first regions of a first color, and second regions of a second color;
(c) setting the colors in the pattern by subjecting substantially the entire surface of the first cholesteric liquid layer to heating or light exposure;
(d) forming a second cholesteric liquid crystal layer on the first cholesteric liquid crystal layer using a cholesteric liquid crystal composition having a photoreactive chiral compound;
(e) forming a pattern by radiating light through a photo-mask onto the second cholesteric liquid crystal layer, having first regions of a color the same or similar to the first color, and second regions of a third color, with a first and second region of the second layer formed on each second region of the first layer, and a second region of the second layer formed on each first region of the first layer; and
(f) setting the colors in the pattern of the second layer by subjecting substantially the entire surface of the second cholesteric liquid layer to heating or light exposure.

6. The method of claim 5, wherein at least one of, the step of forming a first cholesteric liquid crystal layer, and the step of forming a second cholesteric liquid layer, is performed by a coating technique.

7. The method of claim 5, wherein at least one of, the step of forming a first cholesteric liquid crystal layer, and the step of forming a second cholesteric liquid layer, is performed by a transfer technique.

8. The method of claim 5, wherein at least one of the steps of setting the colors in the pattern, is performed using ultraviolet light.

9. A method for manufacturing a cholesteric liquid color filter comprising the steps of:
(a) forming a first cholesteric liquid crystal layer using a cholesteric liquid crystal composition having a chiral compound with a helical twisting power that varies in accordance with temperature;
(b) fixing in the first cholesteric liquid crystal layer, first regions of a first color and second regions of a second, with the first cholesteric liquid crystal layer at one color by radiating light through a photo-mask temperature when fixing the first regions, and at another temperature color by radiating light entirely or through a photo-mask when fixing the second regions;
(c) forming a second cholesteric liquid crystal layer on the first layer using a cholesteric liquid crystal composition having a chiral compound with a helical twisting power that varies in accordance with temperature; and
(d) fixing in the second cholesteric liquid crystal layer, first regions of a color the same or similar to the first color, and second regions of a third color, with a first and second region of the second layer formed on each second region of the first layer, and a second region of the second layer formed on each first region of the first layer, with the second layer at one temperature by radiating light through a photo-mask onto the second layer when fixing the second layer first regions, and the second layer at another temperature by radiating light entirely or through a photo-mask onto the second layer, when fixing the second layer second regions.

10. The method of claim 9, wherein at least one of, the step of forming a first cholesteric liquid crystal layer, and the step of forming a second cholesteric liquid layer, is performed by a coating technique.

11. The method of claim 9, wherein at least one of, the step of forming a first cholesteric liquid crystal layer, and the step of forming a second cholesteric liquid layer, is performed by a transfer technique.

12. The method of claim 9, further comprising the steps of:
(a) irradiating substantially the entire surface of the first cholesteric liquid crystal layer with light after the step of fixing in the first cholesteric liquid crystal layer; and
(b) irradiating substantially the entire surface of the second cholesteric liquid crystal layer with light after the step of fixing in the second cholesteric liquid crystal layer.

13. The method of claim 12, wherein each step of irradiating substantially the entire surface, is performed using ultraviolet light.

14. A transmission type display device comprising a light modulation portion and a light source disposed behind the light modulation portion, the light modulation portion including:
(a) a first cholesteric liquid crystal layer having first regions of a first color and second regions of a second color; and
(b) a second cholesteric liquid crystal layer having first regions of a color the same as or similar to the second color, and second regions of a third color, with a first and second region of the second layer formed on each first region of the first layer, and a second region of the second layer formed on each second region of the first layer.

15. The transmission type display device of claim 14, wherein total area all of the first regions together in the first layer, is different from total area of all the second regions together in the first layer, and total area of all the first regions together in the second layer, is different from total area of all the second regions together in the second layer.

16. The transmission type display device of claim 15, wherein a ratio of total area all of the first regions together in the first layer, to total area of all the second regions together in the first layer is substantially 2:1, and a ratio of total area of all the first regions together in the second layer, to total area of all the seconds regions together in the second layer is substantially 1:2.

17. The transmission type display device of claim 14, wherein the first color is selected from the group consisting essentially of red, blue and green, and the second color is selected from one of the other two remaining colors of the group after the first color has been selected.
